(19) United States
(12) Patent Application Publication
(10) Pub. No.: US 2025/0182497 A1
(43) Pub. Date: Jun. 5, 2025

(54) Method and System for Tracking an Object in a Field of View of a Host Vehicle

(71) Applicant: Aptiv Technologies AG, Schaffhausen (CH)

(72) Inventor: Niclas Carlström, Gothenburg (SE)

(21) Appl. No.: 18/800,368

(22) Filed: Aug. 12, 2024

(30) Foreign Application Priority Data
Nov. 30, 2023 (EP) 23213411

(51) Int. Cl. G06V 20/58; G06V 10/764; G06V 10/98

(52) U.S. Cl. CPC G06V 20/58; G06V 10/764; G06V 10/98

(57) ABSTRACT

A computer-implemented method for tracking an object in a field of view (FOV) of a host vehicle. The method includes detecting and tracking, by a detection and tracking system mounted on the host vehicle, an object in the FOV. The method includes, upon failure of tracking the previously detected object in the FOV, creating, based on a last known position of the previously detected object and for a non-drivable portion of the FOV, a pseudo object representing the previously detected object.

### CROSS-REFERENCE TO RELATED APPLICATIONS

This application claims priority to EP 23213411 filed Nov. 30, 2023, the entire disclosure of which is incorporated by reference.

### FIELD

The present application relates to the field of automotive advanced safety and autonomous driving, and more particular to a method, a system, and a computer-readable storage medium for tracking an object in a field of view (FOV) of a host vehicle.

### BACKGROUND

Advanced Driver Assistance Systems (ADAS) support drivers in order to drive a host vehicle more safely and comfortably. In order to perform properly and due to safety reasons, the environment in front of the host vehicle needs to be monitored, e.g., in order to determine a collision free space in front of the host vehicle. More particularly, safety functions such as Automatic Emergency Brake (AEB) and Adaptive Cruise Control (ACC) may rely on selecting a target vehicle that lies in the forward path of a host vehicle, i.e., a vehicle applying such safety functions. Based on a corresponding selected target vehicle the safety functions may control the host vehicle in such a way that a safe distance and/or a safe relative velocity to the selected target vehicle are maintained.

Accordingly, safety functions are dependent on that an object tracker employed by a host vehicle upstream robustly estimates both existence and states of a target object to be selected. However, if the object tracker for some reason fails to report the target vehicle directly in path of the host vehicle, safety functions such as AEB and ACC may similarly fail since no target object is detected and, hence, no such target object can be selected to be used by the safety functions of the host vehicle. As a result, there is a weakness in known safety systems where a poor object tracker of the host vehicle indirectly may lead to poor performance of safety functions and in worst case even may cause a collision of the host vehicle with another vehicle.

Accordingly, there is a need for improved methods and systems for tracking an object in a field of view (FOV) of a host vehicle.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The invention is defined in the appended independent claims. Advantageous embodiments of the invention are defined in the dependent claims.

One aspect of the present invention relates to a computer-implemented method for tracking an object in a field of view (FOV) of a host vehicle. The method comprises detecting and tracking, by a detection and tracking system mounted on the host vehicle, an object in the FOV. Upon failure of tracking the previously detected object in the FOV, a pseudo object representing the previously detected object is created, based on a last known position of the previously detected object and for a non-drivable portion of the FOV.

By creating a pseudo object representing the previously detected object upon failure of tracking the previously detected object in the FOV, the invention avoids the above mentioned problems caused by a poor object tracker employed by a host vehicle. In particular, the invention ensures that safety functions such as Automatic Emergency Brake (AEB) and Adaptive Cruise Control (ACC) can still be applied even in the case of failure of an object tracking system of a host vehicle. Generally, the invention provides a more robust selection of a target object in front of a host vehicle for safety functions to be applied to a host vehicle.

In an embodiment, the creating of the pseudo object comprises evaluating the FOV of the host vehicle to determine the non-drivable portion of the FOV.

Evaluating the FOV of the host vehicle to determine the non-drivable portion of the FOV allows to compensate for the failure of the detecting and tracking system.

In a further embodiment, the evaluating of the FOV comprises evaluating a grid representation of the FOV, wherein the grid representation comprises a grid of cells, wherein each cell represents a portion of the FOV, and wherein each cell is classified according to a drivability classification, the drivability classification comprising at least drivable or non-drivable.

Using a grid representation of the FOV as claimed allows for an efficient determining of the non-drivable portion of the FOV.

In a further embodiment, the last known position of the previously detected object is defined by a bounding box located in the grid representation and enclosing the previously detected object. The evaluating of the FOV to determine the non-drivable portion of the FOV comprises creating a set of points in the grid representation in an area of a rear edge of the bounding box, determining, in increasing longitudinal direction relative to the bounding box and for each point of the set of points, if the respective point lies within a cell which is classified as non-drivable, and if the respective point lies within a cell which is classified as non-drivable, selecting the respective point as reference point in the grid representation for creating the pseudo object.

In this way, a reliable estimation of the target's current position after failure of the detection and tracking system is provided.

In a further embodiment, each point of the set of points is created to be positioned in the grid representation with a respective offset to the rear edge of the bounding box in longitudinal direction relative to the bounding box.

By applying an offset to the rear edge of the bounding box of the previously detected object, a change in the previously detected object's speed may be compensated for, as the object may have increased or decreased speed.

In a further embodiment, creating the set of points includes creating at least one point within each cell that is comprised in the area of the rear edge of the bounding box.

In this way, it is ensured that the created set of points is dense enough and, hence, the region of interest, i.e., a likely current position of the previously detected object, is sufficiently covered by the set of points.

In a further embodiment, the method further comprises creating, at the reference point in the grid representation, a pseudo bounding box representing the pseudo object. The pseudo bounding box is created with dimensions corresponding to dimensions of the bounding box representing the previously detected object, wherein a rear edge of the pseudo bounding box is positioned at the reference point. Accordingly, the pseudo bounding box is shifted in longitudinal direction relative to the bounding box of the previously detected object. Further, properties of the previously detected object are assigned to the created pseudo object.

In this way, a pseudo object with same properties and dimensions as the previously detected object can be created at a likely current position of the previously detected object, to ensure that, e.g., safety function which rely on a target selection in the forward path of a host vehicle are still applicable to the host vehicle despite failure of the detection and tracking system.

In a further embodiment, creating the set of points is based on a set of parameters.

This allows more flexibility regarding the region of interest in which the previously detected object is likely to be located after loss of its detection and tracking signal.

In a further embodiment, the set of parameters comprises a horizontal distance and/or a vertical distance between two adjacent points in the set of points.

In this way, the density of the created set of points can be adjusted.

In a further embodiment, the set of parameters comprises a number of points to be created.

This is a further parameter which allows to adjust the density of the created set of points.

In a further embodiment, the last known position of the previously detected object is compensated regarding motion of the host vehicle prior to creating the pseudo object.

This allows for a more reliable determining of a current position of the previously detected object and, in turn, a more reliable position of the created pseudo object.

In a further embodiment, the method further comprises selecting the created pseudo object as a target object for applying one or more safety functions.

Using the created pseudo object as a target object for applying one or more safety functions enhances driving safety and may ensure a safe distance and a safe relative velocity to a target vehicle even in the case of a failure of the detection and tracking system.

In a further embodiment, the one or more safety functions comprise at least Automatic Emergency Brake, AEB, and Adaptive Cruise Control, ACC.

Another aspect of the present invention relates to a system comprising means for carrying out the above described computer implemented method.

Still another aspect of the present invention relates to a computer-readable storage medium comprising instructions which, when executed by a computer, cause the computer to carry out the above described method.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 illustrates a typical road scenario.

FIG. 2 illustrates an object tracking scenario.

FIG. 3 illustrates an object tracking scenario after loss of a tracked target.

FIG. 4 illustrates a computer-implemented method for tracking an object in a field of view (FOV) of a host vehicle.

FIG. 5 illustrates a system for tracking an object in a field of view (FOV) of a host vehicle.

In the drawings, reference numbers may be reused to identify similar and/or identical elements.

### DETAILED DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the scope of the disclosure.

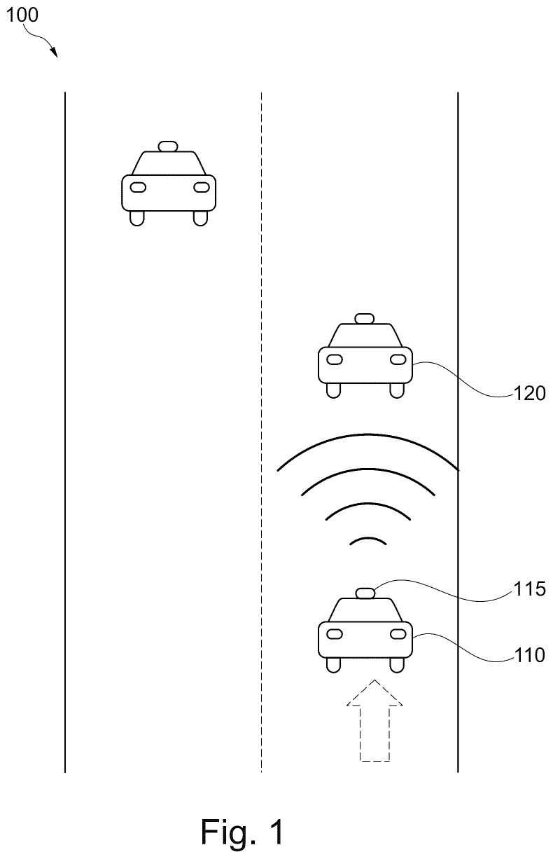

FIG. 1 illustrates a typical road scenario 100 with three vehicles. Ahead of a host vehicle 110, another vehicle 120 is travelling in the forward path (i.e., the field of view, FOV) of the host vehicle 110 (direction indicated by the dashed arrow). A detection and tracking system 115 is mounted on the host vehicle 110. In the scenario shown, the detection and tracking system 115 has detected the other vehicle 120 in the forward path of the host vehicle 110, and is tracking the other vehicle 120 as a target object. The target object may be used for applying, e.g., a safety function, such as AEB (Automatic Emergency Break) and ACC (Adaptive Cruise Control). As detection and tracking system 115, any range sensor may be employed to acquire range detections, such as LiDAR sensors or radar sensors.

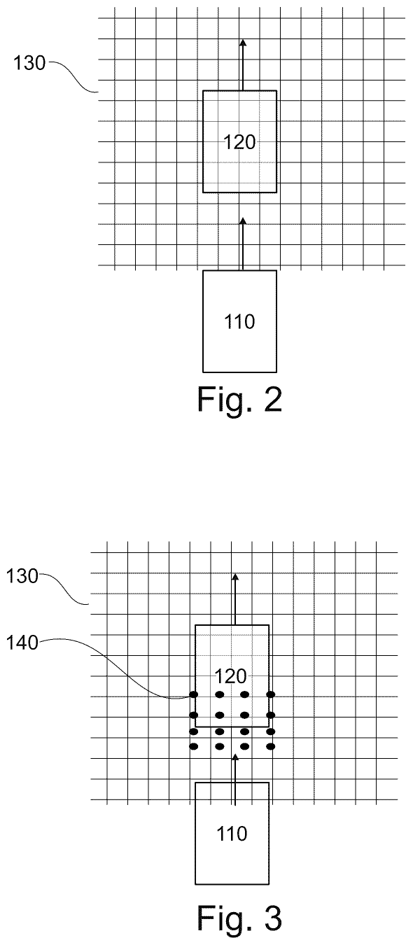

FIG. 2 illustrates a different view of the scenario as shown in FIG. 1. As illustrated in FIG. 2, vehicle 120 in the forward path of host vehicle 110 is detected and tracked via the detection and tracking system 115 as a target object. As shown, the detected vehicle 120 may be represented by a bounding box enclosing the detected vehicle 120. The size of the respective bounding box is considered to correspond to the real object size, i.e., width and length of the corresponding detected and tracked vehicle 120.

As illustrated in FIG. 3, at a certain time, the tracking of the previously detected object 120 in the host vehicle's FOV may fail (indicated by a dashed bounding box representing the loss of the previously detected object 120). In known systems, if the tracking of a previously detected object in the forward path of a host vehicle for some reason fails, features or safety functions such as AEB and ACC may also fail since no target object can be selected for these safety functions. Consequently, a poor object tracker indirectly may lead to poor feature performance and in worst case even cause a collision of the host vehicle and an object in its forward path.

According to the invention, the problem of a sudden loss of a previously detected object in the forward path of a host vehicle is handled by evaluating a grid representation of the surroundings in front of the host vehicle (i.e., the host vehicle's FOV) in the proximity of the previously detected object's last known position, to create a pseudo objection representing the previously detected object 120, which can then be used as target object for the host vehicle's safety functions.

FIG. 3 shows a corresponding scenario of a sudden loss of the previously detected object 120, indicated by a dashed bounding box representing previously detected object 120. FIG. 3 also shows grid representation 130 of the FOV of the host vehicle 110. Grid representation 130 comprises a grid of cells, wherein each cell represents a portion of the FOV, and wherein each cell (and thus each portion of the host vehicle's FOV) is classified according to a drivability classification, the drivability classification comprising at least drivable or non-drivable.

Grid representation 130 may be created and updated using numerous different sources such as Vision lane markers and trails of tracked objects but also radar and vision “freespace” algorithms. A “freespace” algorithm divides the FOV of one or several sensors (such as detection and tracking system 115) into segments and reports a distance for each segment where the segment is occupied (i.e., non-drivable). The algorithm transforms the various sources into cells which yields the grid representation 130, where each cell is classified as either drivable, non-drivable or unknown. Accordingly, grid representation 130 may be used to detect that something is ahead of host vehicle 110 even when the upstream object tracker (such as detection and tracking system 115) suddenly fails to report it.

A non-drivable portion of the FOV may be a hint towards a possible current position of the previously detected object 120. To identify a non-drivable portion of the FOV, i.e., a cell of grid representation 130 classified as non-drivable, the last known position of the previously detected object 120 is saved. In an embodiment, the last known position may optionally be compensated for eventual motion of the host vehicle 110 relative to the previously detected object 120.

As shown in FIG. 3, as the travelling speed of the previously detected object 120 may have changed since the tracking failure, a set of points 140 is created in an area of a rear edge of the previously detected object's bounding box. More specifically, to compensate for a change in the previously detected object's travelling speed, each point 140 is created to be positioned in the grid representation 130 with a certain offset to the rear edge of the bounding box in longitudinal direction relative to the bounding box. The points 140 are then evaluated in the grid representation 130 in increasing longitudinal order. If any point 140 is determined during the evaluation to lie in a cell classified as non-drivable, the respective point 140 is selected as a reference point in the grid representation 130 for creating a pseudo object. In turn, a pseudo bounding box representing the pseudo object is created, wherein the pseudo bounding box is created with dimensions corresponding to dimensions of the bounding box representing the previously detected object 120. As shown in FIG. 3, a rear edge of the created pseudo bounding box is positioned at the reference point 140 in the grid representation 130.

In other words, the pseudo object is created using inherited properties from the previously detected object 120. That is, the created pseudo object has the same properties as the previously detected object 120, except that the longitudinal position of the rear edge of the bounding box enclosing the created pseudo object is shifted to the reference point 140 that has been determined as lying within the first encountered non-drivable cell in the grid representation 130.

To ensure that the created set of points 140 is dense enough and, hence, the region of interest, i.e., a likely current position of the previously detected object, is sufficiently covered by the set of points 140, at least one point 140 is created within each cell that is comprised in the area of the rear edge of the bounding box enclosing the previously detected object 120.

To allow more flexibility regarding the region of interest in which the previously detected object 120 is likely to be located after loss of its detection and tracking signal, the set of points 140 may be created based on a set of parameters. For instance, to adjust the density of the created set of points 140, the set of parameters may comprise a horizontal distance and/or a vertical distance between two adjacent points. In addition or alternatively, the set of parameters may comprise a number of points 140 to be created.

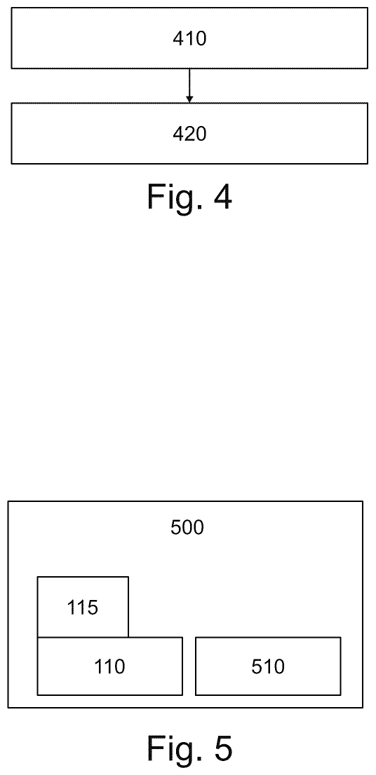

FIG. 4 illustrates a computer-implemented method for tracking an object in a field of view, FOV, of a host vehicle 110. The method comprises a step 410 of detecting and tracking, by a detection and tracking system 115 mounted on the host vehicle 110, an object 120 in the FOV. Upon failure of tracking the previously detected object 120 in the FOV, a pseudo object representing the previously detected object 120 is created in step 420, based on a last known position of the previously detected object 120 and for a non-drivable portion of the FOV.

FIG. 5 illustrates a system 500 for tracking an object in a field of view, FOV, of a host vehicle 110. The system 500 comprises a detection and tracking system 115 mounted on the host vehicle 110, wherein the detection and tracking system 115 is configured for detecting and tracking an object 120 in the FOV. The system further comprises means 510 configured for, upon failure of tracking the previously detected object 120 in the FOV, creating, based on a last known position of the previously detected object 120 and for a non-drivable portion of the FOV, a pseudo object representing the previously detected object 120.

The present invention allows for a more robust target selection even when an upstream object tracker fails and loses track of an existing object. In particular, the present invention may ensure proper operation of safety functions in a host vehicle even in the case of failure of an object tracker employed by the host vehicle, to avoid incidents such as a collision of the host vehicle with another vehicle. The present invention may be useful in many applications of automotive advanced safety and autonomous driving, as it is capable of maintaining feature functionality that requires a target object in a host vehicle's forward path. For example, AEB and ACC features can remain enabled even when an upstream object tracker for some reason fails to report an existing object in the host vehicle's forward path.

The various embodiments described above are provided by way of illustration only and should not be construed to limit the invention. Those skilled in the art will readily recognize various modifications and changes that may be made to the present invention without following the example embodiments and applications illustrated and described herein, and without departing from the scope of the present disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A computer-implemented method for tracking an object in a field of view (FOV) of a host vehicle, the method comprising:
detecting and tracking, by a detection and tracking system mounted on the host vehicle, an object in the FOV; and
upon failure of tracking the previously detected object in the FOV, creating, based on a last known position of the previously detected object and for a non-drivable portion of the FOV, a pseudo object representing the previously detected object.

2. The computer-implemented method of claim 1 wherein the creating of the pseudo object includes evaluating the FOV of the host vehicle to determine the non-drivable portion of the FOV.

3. The computer-implemented method of claim 2 wherein:
the evaluating of the FOV includes evaluating a grid representation of the FOV;
the grid representation includes a grid of cells;
each cell represents a portion of the FOV;
each cell is classified according to a drivability classification; and
the drivability classification including at least drivable or non-drivable.

4. The computer-implemented method of claim 3 wherein:
the last known position of the previously detected object is defined by a bounding box located in the grid representation and enclosing the previously detected object; and
the evaluating of the FOV to determine the non-drivable portion of the FOV includes:
creating a set of points in the grid representation in an area of a rear edge of the bounding box;
determining, in increasing longitudinal direction relative to the bounding box and for each point of the set of points, if the respective point lies within a cell that is classified as non-drivable; and
if the respective point lies within a cell that is classified as non-drivable, selecting the respective point as reference point in the grid representation for creating the pseudo object.

5. The computer-implemented method of claim 4 wherein each point of the set of points is created to be positioned in the grid representation with a respective offset to the rear edge of the bounding box in longitudinal direction relative to the bounding box.

6. The computer-implemented method of claim 4 wherein the creating the set of points includes creating at least one point within each cell that is included in the area of the rear edge of the bounding box.

7. The computer-implemented method of claim 4 further comprising:
creating, at the reference point in the grid representation, a pseudo bounding box representing the pseudo object,
wherein the pseudo bounding box is created with dimensions corresponding to dimensions of the bounding box representing the previously detected object, and
wherein a rear edge of the pseudo bounding box is positioned at the reference point; and
assigning properties of the previously detected object to the created pseudo object.

8. The computer-implemented method of claim 4 wherein the creating the set of points is based on a set of parameters.

9. The computer-implemented method of claim 8 wherein the set of parameters includes a horizontal distance and/or a vertical distance between two adjacent points in the set of points.

10. The computer-implemented method of claim 8 wherein the set of parameters includes a number of points to be created.

11. The computer-implemented method of claim 1 wherein prior to creating the pseudo object, the last known position of the previously detected object is compensated regarding motion of the host vehicle.

12. The computer-implemented method of claim 1 further comprising selecting the created pseudo object as a target object for applying one or more safety functions.

13. The computer-implemented method of claim 12 wherein the one or more safety functions include at least Automatic Emergency Brake (AEB) and Adaptive Cruise Control (ACC).

14. A system for tracking an object in a field of view (FOV) of a host vehicle, the system comprising:
memory hardware configured to store instructions; and
processor hardware configured to execute the instructions, wherein the instructions include:
detecting and tracking, by a detection and tracking system mounted on the host vehicle, an object in the FOV; and
upon failure of tracking the previously detected object in the FOV, creating, based on a last known position of the previously detected object and for a non-drivable portion of the FOV, a pseudo object representing the previously detected object.

15. A non-transitory computer-readable medium comprising instructions including:
detecting and tracking, by a detection and tracking system mounted on a host vehicle, an object in the FOV; and
upon failure of tracking the previously detected object in the FOV, creating, based on a last known position of the previously detected object and for a non-drivable portion of the FOV, a pseudo object representing the previously detected object.
